(19) United States
(12) Patent Application Publication
(10) Pub. No.: US 2015/0294606 A1
(43) Pub. Date: Oct. 15, 2015

(54) Advertising Apparatus

(71) Applicant: Synergy Media, LLC, Winston-Salem, NC (US)

(72) Inventor: H. Christopher Bazos, Pickering (CA)

(73) Assignee: Synergy Media, LLC, Winston-Salem, NC (US)

(21) Appl. No.: 14/682,079

(22) Filed: Apr. 8, 2015

Related U.S. Application Data
(60) Provisional application No. 61/978,277, filed on Apr. 11, 2014.

(51) Int. Cl. G09F 19/18; G03B 21/20; G03B 21/14

(52) U.S. Cl. CPC G09F 19/18; G03B 21/145; G03B 21/2033; G03B 21/2053; G03B 21/147

(57) ABSTRACT

Disclosed is an advertising apparatus capable of motion sensitive projection of a graphic on a surface, such as a floor, comprising: a top; a bottom; a back; two sides; and a front, wherein the top, the bottom, the back, the sides and the front are mechanically coupled together to form the assembled advertising apparatus; a graphics projector for projection of a graphic on a surface; a motion sensor, for detecting motion of a potential customer; a power source to power the advertising apparatus, wherein the graphics projector and the motion sensor are coupled to the power source; and a universal mounting system base plate reversibly coupled to the back.

### FIELD OF THE INVENTION

The present disclosure relates generally to an apparatus for an advertisement. More specifically, the apparatus is a projection system that can project an advertisement to the floor or other surface from a shelf mount.

### BACKGROUND OF THE INVENTION

The broad field of retail advertising has gone through many changes from the time of posting a printed flyer inside a store window to the contemporary development of elaborate displays that are situated in the middle of a store's floor space that are designed to stimulate interest and promote unplanned purchases of the product. Retail advertising is geared to drive customers to consummate the purchase and/or is placed at the point of purchase to assure that the chosen product is kept foremost in the consumer's mind. This medium relies on a mixture of media delivered both outside and inside the retail environment. Examples of media that are delivered inside the retail environment are: paper posters placed in the windows of stores, examples of products on sale placed in the windows of stores, elaborate point-of-purchase displays that stand in the middle of stores' floor space, highlighting the promoted product. It is a goal of advertisers to make their products clearly visible to potential customers and to attract the attention of the potential customers. This is difficult to do, especially in a retail environment where potential customers are bombarded by advertisements and images of products all around them.

### SUMMARY OF THE DISCLOSURE

Disclosed is an advertising apparatus capable of motion sensitive projection of a graphic on a surface, such as a floor, comprising: a top; a bottom; a back; two sides; and a front, wherein the top, the bottom, the back, the sides and the front are mechanically coupled together to form the assembled advertising apparatus; a graphics projector for projection of a graphic on a surface; a motion sensor, for detecting motion of a potential customer; a power source to power the advertising apparatus, wherein the graphics projector and the motion sensor are coupled to the power source; and a universal mounting system base plate reversibly coupled to the back.

### BRIEF DESCRIPTION OF THE DRAWINGS

FIG. 1 is a side perspective view of an exemplary embodiment of an advertising apparatus looking down at the bottom of the apparatus.

FIG. 2 is a back perspective view of the advertising apparatus shown in FIG. 1, rotated 180°.

FIG. 3 is front perspective view of the advertising apparatus shown in FIG. 1.

FIG. 4 is a bottom perspective view of the advertising apparatus shown in FIG. 1 with the cover door removed.

FIG. 5 is a bottom perspective view of the advertising apparatus shown in FIG. 1 with the cover door installed.

FIG. 6 is a digital image of an exemplary lens system for an exemplary projection system of an exemplary embodiment of an advertising apparatus.

FIG. 7 is a rendering of an exemplary device according to the present disclosure installed on a shelf.

FIG. 8 is a rendering of the electronic components of an exemplary device according to the present disclosure.

FIG. 9 is a back perspective view of an alternate embodiment, of the advertising apparatus shown in FIG. 1, rotated 180°.

All illustrations of the drawings are for the purpose of describing selected versions of the present invention and are not intended to limit the scope of the present invention including dimensions and/or configurations.

### DETAILED DESCRIPTION

The singular terms “a,” “an,” and “the” include plural referents unless context clearly indicates otherwise. Similarly, the word “or” is intended to include “and” unless the context clearly indicates otherwise. The term “comprises” means “includes.” In case of conflict, the present specification, including explanations of any terms, will control.

The present disclosure concerns embodiments of an advertising apparatus for dispensing material. The disclosed embodiments are particularly suited for capturing the attention of a potential customer. This is done through projected graphic that can be projected into the path of a potential customer. In some embodiments a motion sensor, such as a passive infrared (PIR) detector, detects the movement of an approaching potential customer and causes lensing system to project a graphic, such as a advertising graphic on the floor or other surface in the path of the potential customer when the potential customer draws near, thus drawing the attention of the customer at the appropriate time, while being programmed to conserve power usage, for example prolonging battery life. The advertising apparatus has the advantage of being mountable to a horizontal or vertical surface, for example using a clamp, magnets, or suction cups and the like. In addition, when mounted, the advertising apparatus has the further advantage of or providing a display surface for additional graphics, such as advertising graphics.

The disclosed advertising apparatus uses electronic means to generate interest in the graphically displayed advertising displayed on the floor in front of the advertising apparatus. This is accomplished by projection of the advertising graphic in a way such that an approaching potential customer sees the advertising graphic and can be drawn to it. Rather than having a sign that is constantly lit or flashes at intervals at a constant rate, which tends to be either lost in the milieu of other sights and sounds or in the case of a constantly flashing sign, somewhat annoying, the disclosed apparatus relies instead on proximity of a potential customer to trigger projection of the advertising graphic from the advertising apparatus, and thus draws attention to the graphic. In essence the light appears out of nowhere when the potential customer is not expecting it and has the effect of grabbing a person's attention which in psychological terms is the called the reticular activating system, e.g. when a person sees something happening in your environment and proceeds to investigate. However, rather than being a simple on off switch activated by proximity, the advertising apparatus disclosed herein includes sophisticated circuitry designed both to attract attention and rest, thereby prolonging battery life of the stand-alone apparatus. No tools are required for installation, which means that it is easy for employees to install the apparatus.

In some examples, a screw diver may need to be used to service a battery door in the back of the apparatus to exchange batteries and/or graphics, which has the benefit of making theft of batteries or graphics difficult.

In example embodiments, the disclosed apparatus uses an LED, such as a 6 watt Cree LED, that shines through an interchangeable parallax graphic through lenses in a tube that projects on the floor, for example a store floor. With the parallax the print image is deliberately distorted that it can be corrected with the lenses in the projector to display a correctly proportioned graphic on the floor in front of a potential customer. This is done so that when the image shows on the floor on an angle the print image is correct.

In example embodiments, the disclosed apparatus has interchangeable brackets for different applications and PIR motion for motion activation. In example embodiments, the disclosed apparatus has the ability to interchange graphics with single slide in graphics (parallax print) that are encased in a plastic housing. This configuration enables the user to just slide the graphic in the side of the projector tube when the projector is opened up, for example through the battery compartment.

One of the many advantages of the disclosed advertising apparatus is that it has the ability to be re-used on a continual basis, e.g. it is not viewed as a single use, single product advertising apparatus. Because both the graphics, and the power supply, in the case of batteries, have the ability to be changed out, the disclosed advertising device has an environmental advantage compared to other conventional point of sale static and lighted signs in the market place. This ability to alter the advertising apparatus's graphics further provides an advantage to the retailer in lowering costs.

With respect to the dimensions shown in the accompanying figures, all dimensions are approximate and not limiting as to the design of the disclosed advertising apparatus.

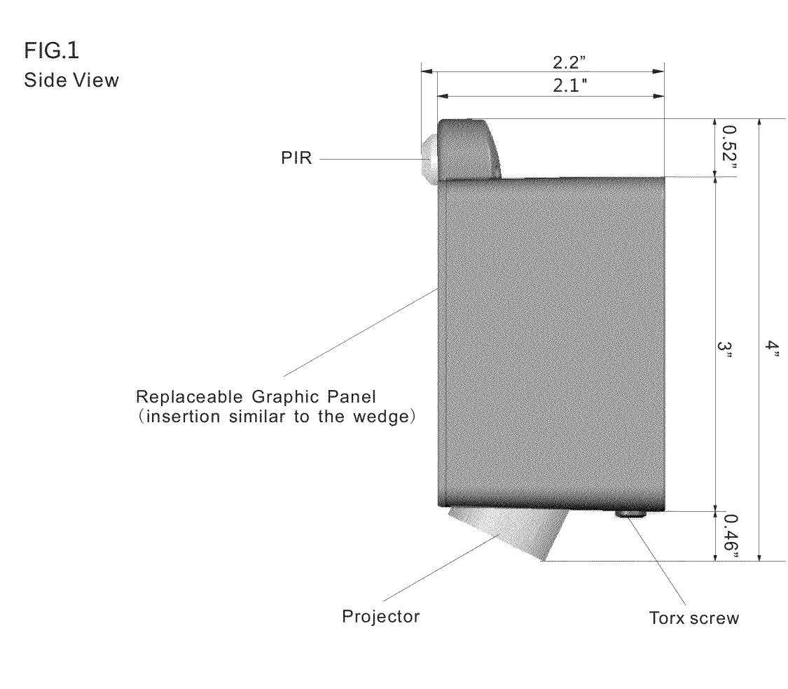

FIG. 1 shows a side view of an exemplary advertising apparatus according to one embodiment. With reference to FIG. 1, the advertising apparatus includes a two sides, one of which is shown, a top, a bottom a front and a back. As shown in FIG. 1 the projector, which can alternatively be referred to herein as a lens system projects outward from the bottom of the advertising apparatus. In alternative embodiments, the projector can be flush with the bottom. The projector would point toward the aisle of a store when installed on a shelf or other surface.

With further reference to FIG. 1, the advertising apparatus also includes a motion detection system, such as a PIR on the front of the advertising apparatus would point toward the aisle of a store when installed on a shelf or other surface. With further reference to FIG. 1, a motion sensor housing is shown protruding from top with a motion sensor mounted. The sensor housing can be positioned anywhere on the outer surface of the top. In certain embodiments, the sensor housing is positioned slightly recessed from the front edge. This provides several advantages; one of which is to prevent or decrease the probability that a potential customer's interaction with the apparatus (such as bumping the apparatus) does not damage the lens portion of the motion sensor mounted in the sensor housing. The effective range of the motion sensor can be tuned, allowing for tuning the apparatus to capture the movement of a potential customer at an optimal range for viewing the projected graphic when it is triggered, for example between about 30 feet or greater, to about 10 feet. In addition, the front facet of the sensor housing can be angled, such that the mounted motion sensor can be directed to the most likely place a customer will travel. This allows the assembled apparatus to be able to be mounted low or high, for example placed on a lower shelf or a higher shelf.

Typically the motion sensor is an infrared sensor, such as a passive infrared sensor, although other motion sensors are contemplated for use in the apparatus. In specific embodiments, the motion sensor is an infrared sensor, such as a multifaceted infrared sensor. Passive infrared sensor sensors allow sensing of motion, by detecting changes in levels of infrared radiation. In some examples, the sensor in a motion detector splits in one or more facets, which can be used to detect a change in motion. In certain embodiments, the multifaceted lens detects the presence of an approaching customer, such as by detecting the body heat of such customer, and as the customer's heat moves across, two, three or even four facets of the lens, it triggers the apparatus. This has the advantage of limiting the interaction to actual potential customers and it also limits it only triggering when the potential customer is actually within range and able to see the display and what's going on with the display. For example, if a customer were to walk part way into the field of the sensors vision, and then reverse course, the sensor would not activate and battery power would be saved, rather than activating for a customer who is now facing the opposite direction.

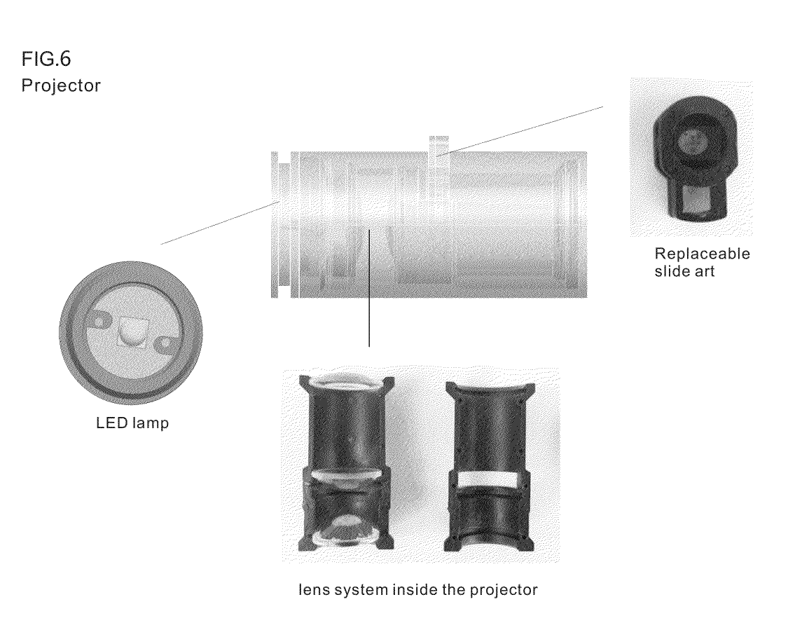

The projection system of the disclosed advertising apparatus is designed to project a brightly lighted advertisement image on a surface, such as on the floor (Floor Graphic) of a retail store when the host advertising apparatus unit is illuminated, thereby heightening the customer's awareness of the featured product(s) (or in some cases cross branding, for example when the projected graphic shows a different product or service than the panel on the front of the apparatus) that are being promoted at that location. In some embodiments, the projection module includes of a set of magnification lenses, (see FIG. 6) that are contained in a tube, a replaceable graphic image slide that fits into a slot in the lens tube (also shown in FIG. 6), an LED lamp, motion sensor positioned to respond to motion of a potential customer.

In some embodiments, the advertising apparatus includes an external power supply, such as a battery pack or external DC or AC power supply. In some embodiments, the advertising apparatus includes an internal power supply, such as batteries, for example a rechargeable battery, and optionally a port for recharging the batteries.

The floor projector projection angle is adjustable to compensate for different shelf height levels that the advertising apparatus may be mounted on. The system is reusable as the graphic slide image can be changed and the power supply can be replenished or operated on external AC mains power.

The disclosed projection module uses electronic means to generate interest in the graphically displayed advertising projected onto a surface. This is accomplished by projecting advertising graphics within the lensing system in a way such that an approaching potential customer sees the projected advertising graphic and can be drawn to it. Rather than having a sign that is constantly lit or flashes at intervals at a constant rate, which tends to be either lost in the milieu of other sights and sounds or in the case of a constantly flashing sign, somewhat annoying, the disclosed projection module relies instead on proximity of a potential customer to trigger projection of advertising graphics, and thus draw the attention to the apparatus and it accompanying graphics of the projection as well as the illuminated graphics on the advertising apparatus' surface. No tools are required for installation.

FIG. 1 also shows the position of a replaceable graphic on the front of the advertising apparatus. Typically, this replaceable graphic is not illuminated. However, in certain embodiments, this graphic can be illuminated, for example at the same time under control of the motion sensor as the projected graphic. For example the front of the advertising apparatus can be configured to be surface illuminated, for example that can be lit with light emitting diodes (LEDs) or an electroluminescence (EL) light source and the like, such that the surface give off light, glow or appear illuminated. This, in turn, illuminates a graphic, such as graphics depicting a particular product or service. For example, an advertisement for a product or service, placed on the surface of the front can be illuminated for a potential customer. It is contemplated that the graphics would be inter changeable, for example as thin sheet of printed plastic and the like placed on the surface of the front of the advertising apparatus; however, it is also contemplated that the graphics could be directly placed in the surface of the front of the advertising apparatus for example printed. The advertising graphics can be replaced easily by sliding precut sheets of material into small channels between the top, bottom and sides.

The advertising apparatus can be made of any material, however plastic, such as thermo-moldable plastic is preferred. In the case where the front can be illuminated, the front is typically made of a substantially clear material, such that when the material is edge lit, light passes through the material. In some embodiments, the front sides are light guides, by light guide it is meant that when the material is edge lit, the light is guided across the material and can be further guided to illuminate that face of the material in a uniform manner or substantially uniform manner. In some embodiments, this is done using a piece of plastic that has been printed so that it has spots on it that disperse the light to the face of the material. Alternatively, such edge-lens technology uses small bumps and/or indentations that guide the light to the surface of the material and illuminate the display surfaces. Essentially, this technology pulls the light across the plane evenly. For example, for a 4×4 piece of acrylic and with only one edge lit printing and/or etching pulls the light evenly across the acrylic back lighting the piece. In some embodiments, the light or illumination source is electroluminescence (EL). EL is an optical phenomenon and electrical phenomenon in which a material emits light in response to the passage of an electric current or to a strong electric field. Examples of the range of EL materials include thin-film zinc sulfide doped with manganese and semiconductors containing Group III and Group V elements, such as indium phosphide (InP), gallium arsenide (GaAs), and gallium nitride (GaN). Typically the EL material is a thin film, which can be mechanically couple to a backer, such as a plastic backer, for example the front sides of the disclosed advertising apparatus. Electroluminescent technologies have low power consumption, and are thus well suited to the use in the disclosed advertising apparatus.

While a particular shape of the advertising device is shown in FIG. 1, a variety of shapes are contemplated.

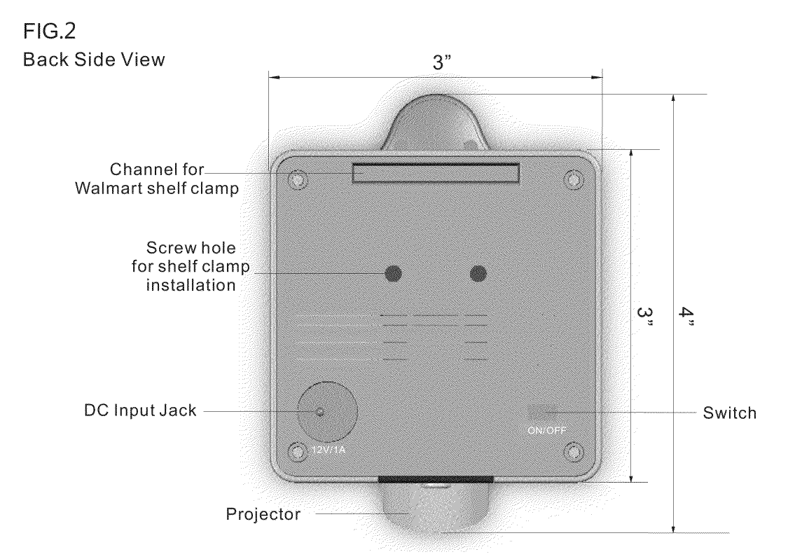

FIG. 2 shows a back view of an exemplary advertising apparatus according to one embodiment. Also shown is the optional the charging and/or AC/DC adaptor plug mounting hole with charging and/or AC/DC adaptor plug removed. The location of the optional charging and/or AC/DC charging and/or AC/DC adaptor plug mounting hole can be placed as desired, including the top or back.

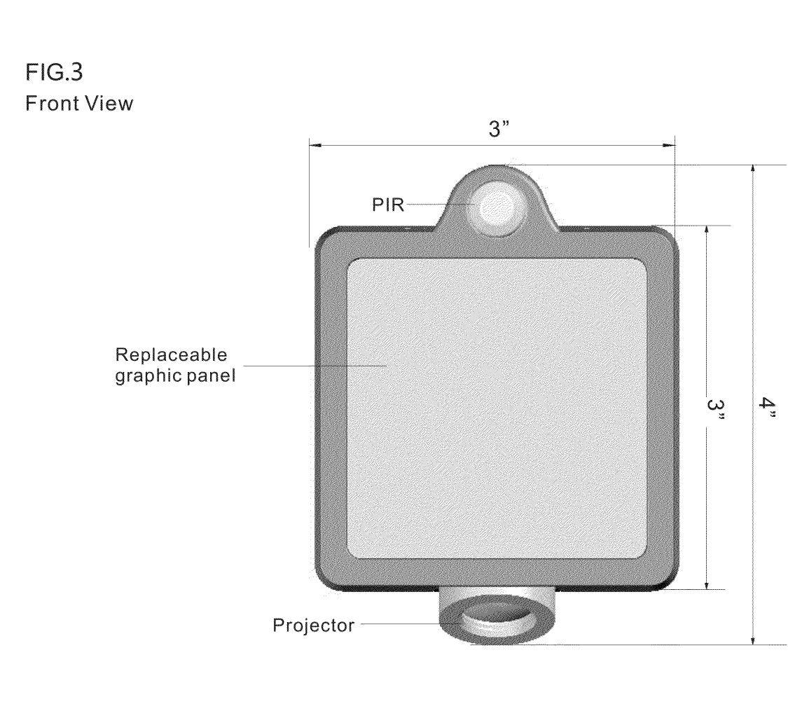

FIG. 3 shows front view of an exemplary advertising apparatus according to one embodiment.

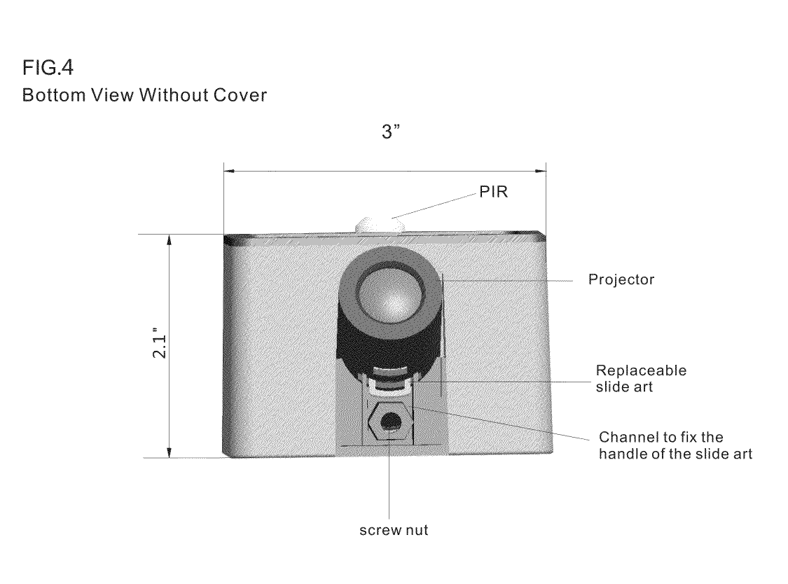

FIG. 4 shows a bottom view of an exemplary advertising apparatus according to one embodiment, with the cover removed for exchanging a projectable graphic. FIG. 4 also shows the projector and a slot therein for the replaceable graphics inserts.

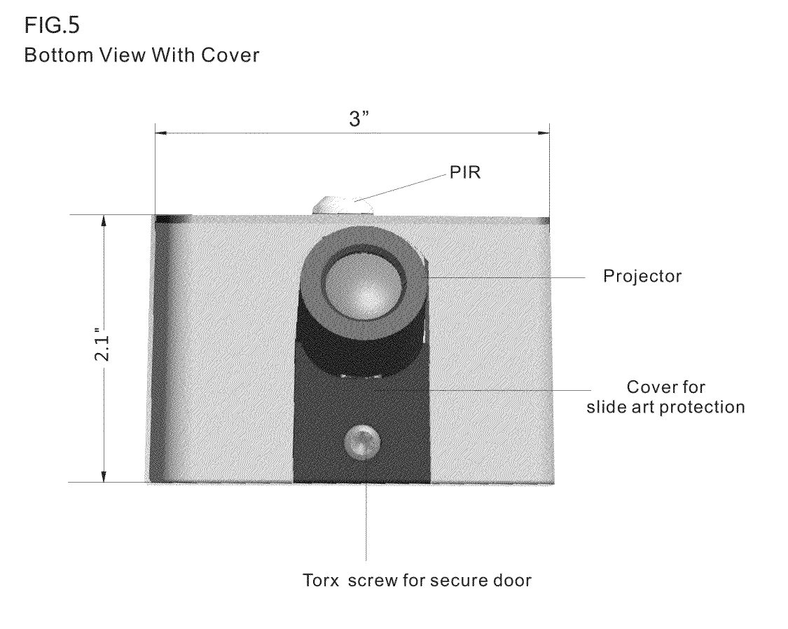

FIG. 5 shows the bottom of the advertising apparatus in FIG. 4, with the battery compartment cover in place.

FIG. 6 shows an exemplary lens system for an of an exemplary projection unit. Also shown is the replaceable insert.

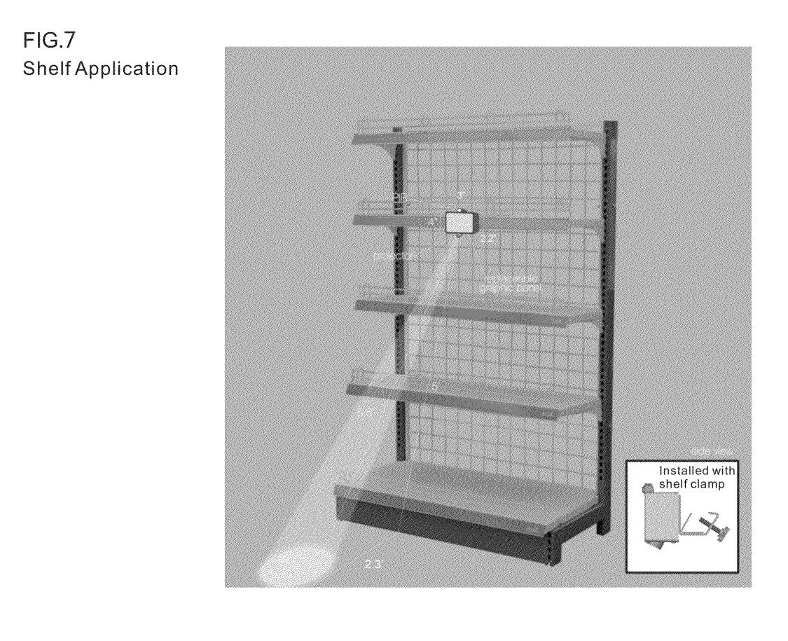

FIG. 7 is a rendering of an exemplary advertising apparatus installed on a shelf, according to the present disclosure. The projection module is configured to project an advertisement on the floor below the surface. Placement of the projected advertising is shown.

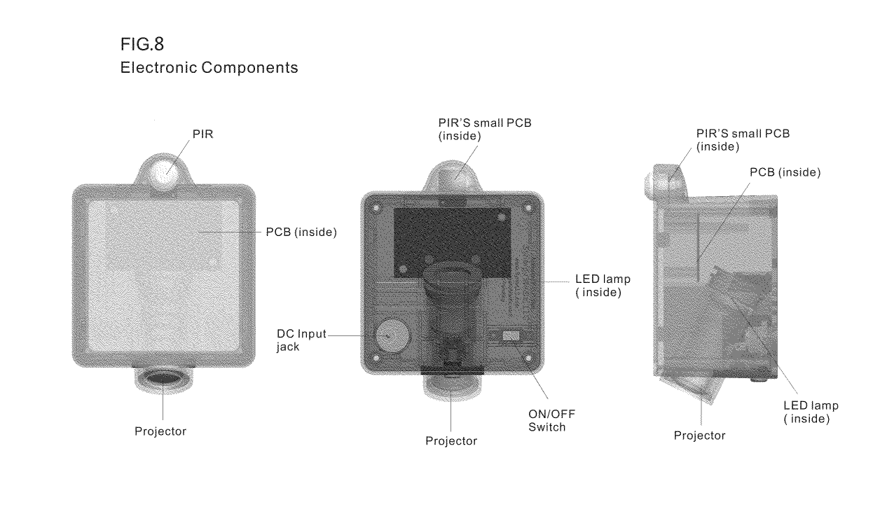

FIG. 8 is rendering showing the internal components of an exemplary advertising apparatus.

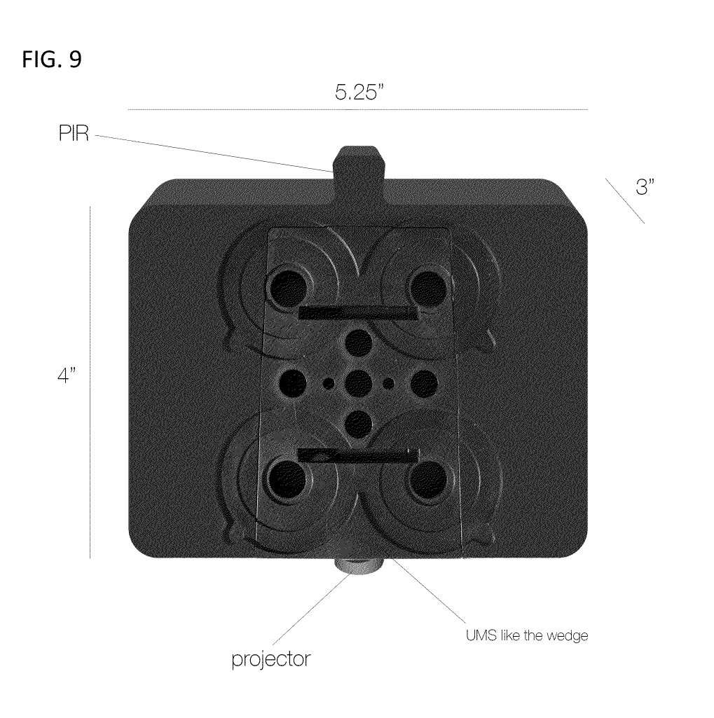

FIG. 9 shows an alternative embodiment, with the back view showing a universal mounting system (UMS) which can be used to mount the advertising device to a shelf or other surface. With reference to FIG. 9, the motion sensor housing is clearly visible protruding from the top. This view also shows the universal mounting system slotted into the back. The universal mounting system addresses several challenges present in an advertising environment. First is mounting, given the diversity in mounting situations, such as different size shelving, a universal mounting system was developed that provides the ability to customize the apparatus to a variety of situations likely to be encountered. The universal mounting system that includes a universal mounting system base plate that slips into a slot on the back of the advertising apparatus and locks in place. The universal mounting system is configured to accommodate a variety of mounting hardware. In one embodiment, the universal mounting system includes a clamp that can be finger tightened for placement on a horizontal shelf and attaches to the universal mounting system base plate. In another embodiment, the universal mounting system includes a magnetic attachment that attaches to the universal mounting system base plate. In another embodiment, the universal mounting system includes one or more suction cups that attaches to the universal mounting system base plate. The clamp mounting hardware is typically a C-shaped steel bracket. For suction cup mounting, between about 1 and about 16 suction cups can be used, such as 1, 2, 3, 4, 5, 6, 7, 8, 9, 10, 11, 12, 13, 14, 15, or 16 suction cups, depending on the application.

In some embodiments, the sides of the universal mounting base plate are substantially non-parallel, such that the universal mounting base plate fits securely in the channel of the back piece of the advertising apparatus. One advantage of using the substantially non-parallel sides of the universal mounting system base plate is that it allows the universal mounting system base plate to slide it up and down and lock in place with a simple cam lock, with all of the weight supported at the top and on the sides, so there's no one area of the universal mounting system base plate that is bearing an unreasonable amount of weight.

The universal mounting system base plate includes seeding tabs, mounting holes, guide tabs, clamp mounting slots and suction cup mounting holes. The universal mounting system base plate includes several features to mount additional optional mounting hardware. The mounting holes can be used to mount additional hardware using fasteners for placement of the assembled apparatus, including as clamp. The clamp mount can be guided though the clamp mounting slots and attached with fasteners to the universal mounting system base plate using fatteners to the mounting holes. In addition, suction cups can be mounted to the suction cup mounting holes. Guide tabs and seeding tabs position universal mounting system base plate within the channel on the back piece of the advertising apparatus.

In view of the many possible embodiments to which the principles of our invention may be applied, it should be recognized that illustrated embodiments are only examples of the invention and should not be considered a limitation on the scope of the invention. Rather, the scope of the invention is defined by the following claims. We therefore claim as our invention all that comes within the scope and spirit of these claims.

We claim:

1. An advertising apparatus capable of motion sensitive projection of a graphic on a surface, such as a floor, the apparatus comprising:
a top;
a bottom;
a back;
two sides;
and a front, wherein the top, the bottom, the back, the sides and the front are mechanically coupled together to form the assembled advertising apparatus;
a graphics projector for projection of a graphic on a surface;
a motion sensor, for detecting motion of a potential customer;
a power source to power the advertising apparatus, wherein the graphics projector and the motion sensor are coupled to the power source; and
a universal mounting system base plate reversibly coupled to the back.

2. The advertising apparatus of claim 1, further comprising a battery compartment.

3. The advertising apparatus of claim 1, wherein the top further comprises a motion detector housing and wherein the motion detector is mechanically coupled to the motion detector housing.

4. The advertising apparatus of claim 1, further comprising a locking mechanism to lock the universal mounting system reversibly coupled to the back piece.

5. The advertising apparatus of claim 1, wherein the motion sensor is a multifaceted passive infrared motion sensor.

6. The advertising apparatus of claim 1, further comprising a power switch coupled to the power source to power the advertising apparatus up or down.

7. The advertising apparatus of claim 1, further comprising a battery compartment cover.

8. The advertising apparatus of claim 1, further comprising a charging and/or AC/DC adaptor plug, for charging, and/or powering the advertising apparatus.

9. The advertising apparatus of claim 1, wherein the graphics projector comprises illumination source.

10. The advertising apparatus of claim 1, wherein the illumination source is one or more light emitting diodes (LED).

11. The advertising apparatus of claim 9 further comprising a controller for the illumination source coupled to the power supply and the illumination source.

12. The advertising apparatus of claim 11, further comprising a circuit board comprising a circuit, wherein the illumination source, the motion sensor, the controller for the illumination source and the power source are coupled to the circuit.

13. The advertising apparatus of claim 9, wherein the graphics projector comprises interchangeable graphics.

14. The advertising apparatus of claim 13, wherein the interchangeable graphics are parallax print images deliberately distorted such that it can be corrected with the lenses in the graphics projector to display a correctly proportioned graphic on the floor in front of a potential customer.

15. The advertising apparatus of claim 13, wherein the interchangeable graphics are encased in a plastic housing that slides into the graphics projector.

16. The advertising apparatus of claim 1, wherein the front comprises interchangeable graphics.

17. The advertising apparatus of claim 1, wherein the front is capable of edge illumination.
